(19) United States
(12) Patent Application Publication
(10) Pub. No.: US 2010/0048133 A1
(43) Pub. Date: Feb. 25, 2010

(54) AUDIO DATA FLOW INPUT/OUTPUT METHOD AND SYSTEM

(75) Inventors: Yao Wang, Beijing (CN); Dongmei Lu, Beijing (CN)

Correspondence Address: CHALKER FLORES, LLP, 2711 LBJ FRWY, Suite 1036, DALLAS, TX, 75234, US

(73) Assignee: IVT (BEIJING) SOFTWARE TECHNOLOGY, INC., Beijing (CN)

(21) Appl. No.: 12/527,186

(22) PCT Filed: Feb. 13, 2008
(86) PCT No.: PCT/CN08/00337

§ 371 Date: Oct. 23, 2009

(30) Foreign Application Priority Data
Feb. 13, 2007 (CN) CN200710063852.5

(51) Int. Cl. H04B 7/00

(52) U.S. Cl. 455/41.3

(57) ABSTRACT

This invention relates to a method used to switch input/output audio data streams seamlessly and related digital devices, wherein the digital device comprises a local physical sound card, a short-distance wireless communication module and an audio switching management module. When a wireless audio transmission channel is connected, the audio switching management module automatically passes the output audio data stream by an audio application module to a wireless audio device through the wireless audio transmission channel and passes the input audio data stream to the audio application module through the wireless audio transmission channel. When the wireless audio transmission channel is disconnected the audio switching management module automatically passes the output audio data flow to a wired audio device through the local physical sound card and passes the input audio data flow from the wired audio device to the audio application module through the local physical sound card.

### FIELD OF THE INVENTION

This invention relates to field of wireless communication technology, and more particularly, to method, device, system, computer system and storage media for inputting and/or outputting audio data stream.

### BACKGROUND OF THE ART

The advent of wireless technologies (such as Bluetooth, Wi-Fi, and UWB) helps users to listen music and make calls wirelessly. In the implementation, both audio transmitting devices (such as computers, PDA, and mobiles) and audio receiving devices (such as headsets, sound boxes, and cordless phones) have a wireless transceiver, respectively. Audio data streams of audio transmitting devices are passed wirelessly to audio receiving devices of user terminal.

Taken Bluetooth technology as an example, in Bluetooth audio application, Bluetooth provides SCO/eSCO link to transmit real-time voice signals of low sampling frequency, so that users can conveniently receive or dial phones by handsets (Headset, Hands Free, Cordless Telephone Profile); at the same time, it transmits audio encoding data (MP3, SBC and other audio encoding format) with high quality through ACL link of Bluetooth audio application with high quality (A2DP Profile), so users can listen to the music conveniently.

Usually, in an operating system of Bluetooth device, Bluetooth virtual sound card (meaning software module to realize audio data stream acquisition and output) should be incorporated into the operating system (such as Windows or Linux system) in order to implement the support to Bluetooth audio application. Audio application module (Media player, RealPlayer, Skype, etc) will output audio data stream to Bluetooth virtual sound card via operating system, and Bluetooth virtual sound card will pass audio data stream to Bluetooth communication module, and then send to remote Bluetooth audio device via Bluetooth audio communication channel. Following the reverse direction, Bluetooth communication module will receive audio data stream from remote Bluetooth audio device via Bluetooth audio communication channel, and virtual sound card will pass the said audio data stream to audio application module.

Corresponding to Bluetooth audio application, Bluetooth devices also contain local physical sound card (not limited to the common concept of sound card, some of which are called as audio device or others) by hardware to acquire and output data stream. Audio data stream played by audio application module in operating system can be transmitted to wired audio device via local physical sound card (such as PDA speaker, headsets or sound boxes connecting computer interfaces by wire). Following the reverse direction, audio data stream can be transmitted to local physical sound card via microphone of computer and PDA interfaces with wired connection, and then the said data stream is sent to audio application module.

At present, users can listen music and make Skype and MSN calls with wired audio devices, and then change to use Bluetooth audio device (Bluetooth headset) if they want. At this moment, when Bluetooth audio connection is established, default input sound card and default output sound card to input/output audio data stream in operating system can automatically be switched from local physical sound card to Bluetooth virtual sound card. Because several audio application modules(such as Skype) provide interfaces,

Bluetooth application module can send related commands to inform audio application module that default sound card has been set as Bluetooth virtual sound card, and thus audio application module can recognize the said sound card and input/output audio data stream from/to Bluetooth virtual sound card. However, if the current audio application module intends to finish switching, audio application module must turn off the open local physical sound card, interrupt the current audio application, and turn on default sound card of the system (that is, Bluetooth virtual sound card) again, and even restart audio application module. The sudden interruption of audio application makes users feel not well. Or, when users listen to music or make calls via Bluetooth audio devices at the beginning, if Bluetooth audio communication channel is disconnected or Bluetooth audio devices are discharged, users will hope to receive and/or record audio data stream via wired audio devices. At the time, although Bluetooth application module can automatically switch input/output audio data stream by default input sound card and default output sound card in operating system from Bluetooth virtual sound card to local physical sound card, the audio application module must turn off the open Bluetooth virtual sound card, interrupt the current audio application, and turn on default sound card of the system (that is, local physical sound card) again, and even restart audio application module, if the current audio application module intends to finish switching. The audio application is also interrupted.

This shows that audio data stream input/output by audio application module cannot realize to switch seamlessly inputting/outputting between Bluetooth audio communication channel and local physical sound card, which brings inconvenience to users. For those situations with high requirements for audio data stream input/output real-time, including making Skype calls, seeing the movies online, playing games, the previous situation cannot be followed if audio application module is restarted, which makes users fell bad. The similar problems also exist for other wireless audio applications, such as Wi-Fi and UWB.

### SUMMARY OF THE INVENTION

In view of defects of current technologies, it is necessary to find a software method to switch input/output audio data stream of audio application module seamlessly, digital device, system, computer program, and storage media containing above computer program, so that users can seamlessly switch between wired audio input/output devices and wireless audio input/output devices while they need not restart audio application module or interrupt current audio application.

This invention can solve the above problems through method for inputting/outputting audio data stream, digital device, system, computer program, and storage media containing above computer program, wherein the said digital device comprises:
audio application module;
at least one local physical sound card and at least one short-range wireless communication module (it should be pointed out that devices in operating system to acquire and output audio data stream by hardware are called as local physical sound card.). Output audio data stream of audio application module can be sent from local physical sound card to wired audio device, and from wireless audio communication channel of short-range wireless communication module to wireless audio devices; following the reverse direction, output audio data stream of wired audio device can be sent from local physical sound card to audio application module, output audio data stream of wireless audio device can be transmitted from wireless audio communication channel to audio application module;
audio switch management module, which is used to get audio data stream from audio application module and send through local physical sound card or short-range wireless module, and then send input audio data stream by local physical sound card or short-range wireless module to audio switch management module.

When short-range wireless communication module establishes the connection of a wireless audio communication channel, audio switch management module will automatically switch audio data stream output by audio application module to the said wireless audio communication channel, and then to wireless audio device, and stop passing the said audio data stream form local physical sound card to wired audio device. At the same time, the said audio switch management module can get audio data stream from wireless audio device to audio application module via the said wireless audio communication channel, and stop passing audio data stream from wired audio device to local physical sound card. When the said short-range wireless communication module disconnects with wireless audio communication channel, audio switch management module will automatically switch audio data stream from audio application module to local physical sound card, and stop passing the said audio data stream to the said short-range wireless communication module. At the same time, the said audio switch management module can get audio data stream from wired audio device to audio application module via local physical sound card, and stop passing audio data stream from wireless audio device to the said wireless audio communication channel. When the said short-range wireless communication module connects or disconnects with wireless audio communication channel, audio data stream input/output by audio application module will be switched between local physical sound card and wireless audio communication channel of short-range wireless communication module. During the process of the above switch, it is not necessary for audio application module to stop passing audio data stream or re-designate audio data stream input/output device in operating system.

According to present invention, in order to, switch seamlessly audio data stream input/output in operating system by software method, audio switch management module should get output audio data stream of audio application module, and input data streams from wireless audio device to wireless audio communication channel, and input data streams from wired audio device to local physical sound card.

One way of implementation is to add at least one virtual sound card in audio switch management module, which is used to realize module of audio data stream acquisition and output. The said virtual sound card has nothing to do with types of short-range wireless communication module and wireless audio communication channel. In operating system, either local physical sound card or virtual sound card is chosen as default input sound card of input audio data stream, either local physical sound card or virtual sound card is chosen as default output sound card of output audio data stream. Default input sound card and default output sound card can be the same card, or the two different cards. When audio application module sets input sound card and output sound card by default, the said module will get input audio data stream via the said default input sound card and output audio data stream via the said default output sound card. Users can designate some sound card as input sound card of audio application module, and some sound card as output sound card of audio application module. The designated input sound card and output sound card can be the same one, or the two different sound cards. The said audio application module can receive input audio data stream from the said input sound card, and pass output audio data stream from the said output sound card. Preferably, when audio switch management module is activated, virtual sound card will be automatically set as default input sound card and default output sound card of audio data stream in operating system. At this time, it is virtual sound card, not local physical sound card, that gets input/output audio data stream of audio application module. When audio switch management module stops working, and local physical sound card is set as default input and output sound card of audio data stream in operating system, local physical sound card will receive directly input/output audio data stream from audio application module.

Another way of implementation is to add a filter driver in audio switch management module. Different from virtual sound card, the said filter driver is located between audio application module and local physical sound card. For users, filter driver and local physical sound card are shown as a sound card (local physical sound card). The said filter driver can intercept audio data stream from audio application module to local physical sound card, and then send the said stream to wireless audio device via wireless audio communication channel of short-range wireless communication module, or to wired audio device via local physical sound card. In the same way, the said filter driver can receive audio data stream from wireless audio device to wireless audio communication channel, or receive audio data stream from wired audio device to local physical sound card, and then send to audio application module.

In the present invention, according to the connection state of wireless audio communication channel of wireless communication module, audio switch management module can control to choose inputting/outputting audio data stream of audio application module, obtained by virtual sound card or filter driver, through local physical sound card or wireless audio communication channel of short-range wireless communication module. Therefore, the sign of connection state in wireless audio communication channel is set in short-range wireless communication module to identify whether the said channel is connected or disconnected. The said short-range wireless communication module gives a real-time test to the state of the said wireless audio communication channel. Once the state of channel is changed, the module will update the sign of connection state and inform audio switch management module. When the sign shows that wireless audio communication channel of the said short-range is connected, audio switch management module will send audio data stream, which virtual sound card or filter driver obtains from audio application module to operating system, from the said wireless audio communication channel to wireless audio device, and stop passing the stream from local physical sound card to wired audio device. At the same time, the module also will control virtual sound card or filter driver to obtain audio data stream of wireless audio device from the said wireless audio communication channel, and send to audio application module, and let local physical sound card stop obtaining audio data stream from wired audio device. When the sign shows that wireless audio communication channel of the said short-range is disconnected, audio switch management module will send audio data stream, which virtual sound card or filter driver obtains from audio application module to operating system, from local physical sound card to wired audio device, and stop passing the said stream from the said wireless audio communication channel to wireless audio device. At the same time, the module also will control virtual sound card or filter driver to obtain audio data stream from wired audio device through local physical sound card, and send to audio application module, and let wireless audio communication channel stop obtaining audio data stream from wireless audio device.

If only one virtual sound card is added to audio switch management module, whereas there are more than two similar or different wireless audio communication channel of multiple short-range wireless communication modules (such as Bluetooth audio communication, Wi-Fi audio communication channel, and UWB channel audio communication channel), the said virtual sound card will send audio data stream, which is obtained from audio application module to operating system, to the said multiple wireless audio communication channel or local physical sound card, and at the same time, the said virtual sound card will get the above data stream from multiple audio communication channel or local physical sound card, and then send to audio application module after audio mixing. For example, the music played through RealPlayer can be sent form two Bluetooth application ACL communication channels to two Bluetooth headsets, or from one Bluetooth application ACL communication channels to one Bluetooth headset, or from five Wi-Fi audio communication channels to Wi-Fi speaker with five audio channels. When all the wireless audio communication channels of multiple short-range wireless communication module are disconnected, audio switch management module will switch audio data stream, which virtual sound card obtains from audio application module, to local physical sound card, and stop passing the said audio data stream to the said multiple wireless audio devices; at the same time, the module also will control virtual sound card to obtain audio data stream from the wired audio communication channel, and send to audio application module, and let multiple wireless audio communication channels stop obtaining audio data stream from wireless audio device. When at least one wireless audio communication channel of multiple short-range wireless communication modules is connected, audio switch management module will send audio data stream, which virtual sound card obtains from audio application module, to at least one wireless audio communication channel, and let local physical sound card stop passing the said audio data stream to wireless audio device. At the same time, the module also will control virtual sound card to obtain audio data stream, input by wireless audio device, through at least one connecting wireless communication, and then send to audio application module, and let local physical sound card stop obtaining audio data stream from wired audio device.

In an operating system, two or more than two audio application modules are used. For example, one is listening to RealPlayer music, and another is making Skype call with wireless headset. In such a case, if only one virtual sound card is added to audio switch management module, the said virtual sound card will obtain audio mixing data stream which multiple audio application modules are sending together to operating system by default, because the said virtual sound card is set as default input/output sound card of audio data stream in operating system. Thus, users are bothered to listen well. To solve this problem, an optimized plan, but not limited to, is to add two or more than two virtual sound card in audio switch management module, which are used as input/output sound cards of audio data stream from/to multiple audio application module, that is to say, one audio application module corresponds to one virtual sound card, in order to realize audio data stream input/output in operating system, and intercross with wireless audio device through corresponding wireless audio communication channel.

According to an optimized embodiment of this invention, audio switch management module has two virtual sound cards, that is, the first virtual sound card and the second virtual sound card. The first one is designated as the input and output sound card of the first audio application module and the second one is designated as the input and output sound card of the second audio application module. When the first wireless audio communication channel is connected, the said audio switch management module will switch audio data stream, which the first virtual sound card obtains from the first audio application module, to the first wireless audio communication channel, and let local physical sound card stop passing the said audio data stream to wired audio device. At the same time, the module also will control the first virtual sound card to obtain audio data stream from wireless audio device to the first wireless audio communication channel, and send to the first audio application module, and let local physical sound card stop obtaining audio data stream from wired audio device. When the first wireless audio communication channel is disconnected, the said audio switch management module will switch audio data stream, which the first virtual sound card obtains from the first audio application module, to local physical sound card, and stop passing the said audio data stream to the first wireless audio communication channel. At the same time, the module also will control the first virtual sound card to obtain audio data stream from wired audio device to local physical sound card, and send to the first audio application module, and let the first audio communication channel stop obtaining audio data stream from the wireless audio device. When the second wireless audio communication channel is connected, the said audio switch management module will switch audio data stream, which the second virtual sound card obtains from the second audio application module, to the second wireless audio communication channel, and let local physical sound card stop passing the said audio data stream to wired audio device. At the same time, the module also will control the second virtual sound card to obtain audio data stream from wireless audio device to the first wireless audio communication channel, and send to the second audio application module, and let local physical sound card stop obtaining audio data stream from wired audio device. When the first wireless audio communication channel is disconnected, the said audio switch management module will switch audio data stream, which the second virtual sound card obtains from the second audio application module, to local physical sound card, and stop passing the said audio data stream to the second wireless audio communication channel. At the same time, the module will control the second virtual sound card to obtain audio data stream from wired audio device to local physical sound card, and send to the second audio application module, and let the second audio communication channel stop obtaining audio data stream from wireless audio device.

In addition, in the above application scene of multiple audio application modules, if two or more than two wireless audio communication channels, corresponding to input/output audio data stream of audio application modules, are disconnected together, it is necessary for the audio switch management module to receive/send audio data stream from/to multiple audio application module to/from local physical sound card. In order to avoid sound mixing and resource conflict, the audio switch management module, in accordance with optimized strategy, can choose automatically one of audio application modules to receive/send audio data stream from/to local physical sound card. For example, when both Bluetooth SCO/eSCO communication channel and ACL communication channel are disconnected together, Skype audio data stream will prefer to switch from/to Bluetooth SCO/eSCO communication channel to/from local physical sound card, while RealPlayer audio data stream, output through Bluetooth ACL communication channel, will not switch to local physical sound card. Certainly, users can first choose to switch from local physical sound card to audio application module through UI prompt.

In the present invention, it does not need to make any change to interface or application of present audio application module. The solution is compatible and easy to use. In the process to switch automatically and seamlessly the audio data stream of audio application module between wireless audio communication channel and local physical sound card, audio application module does not need to stop passing audio data stream or re-designate default sound card of audio data stream between audio application module and operating system, thereby solving the complex operation of existing technology.

### BRIEF INTRODUCTION OF THE DRAWINGS

It'll be helpful for those skilled in the art to understand the objects and advantages of present invention by the following detailed description of embodiment with reference to the drawings, wherein:

FIG. 1 is the diagram that audio data stream, which is output from/input to audio application module, is input to/output from local physical sound card in existing technology.

FIG. 2 is the diagram of audio data stream, which is output from/input to audio application module to/from wireless audio communication channel in existing technology.

FIG. 3 is an optimized embodiment of this invention, the diagram of input/output audio data stream from/to audio application module switching seamlessly by software method between wireless audio communication channel and local physical sound card.

FIG. 4 is an optimized embodiment of this invention, the diagram of input/output audio data stream from/to audio application module switching seamlessly by software method between wireless audio communication channel and local physical sound card.

FIG. 5 is, according this invention, the diagram of output audio data stream from audio application module switching seamlessly by software method between wireless audio communication channel and local physical sound card.

FIG. 6 is, according this invention, the diagram of input audio data stream to audio application module switching seamlessly by software method between wireless audio communication channel and local physical sound card.

FIG. 7 is, according this invention, the diagram of switching seamlessly by software method of two Bluetooth audio applications in accordance with optimized strategy.

### DETAILED DESCRIPTIONS OF THE EMBODIMENTS

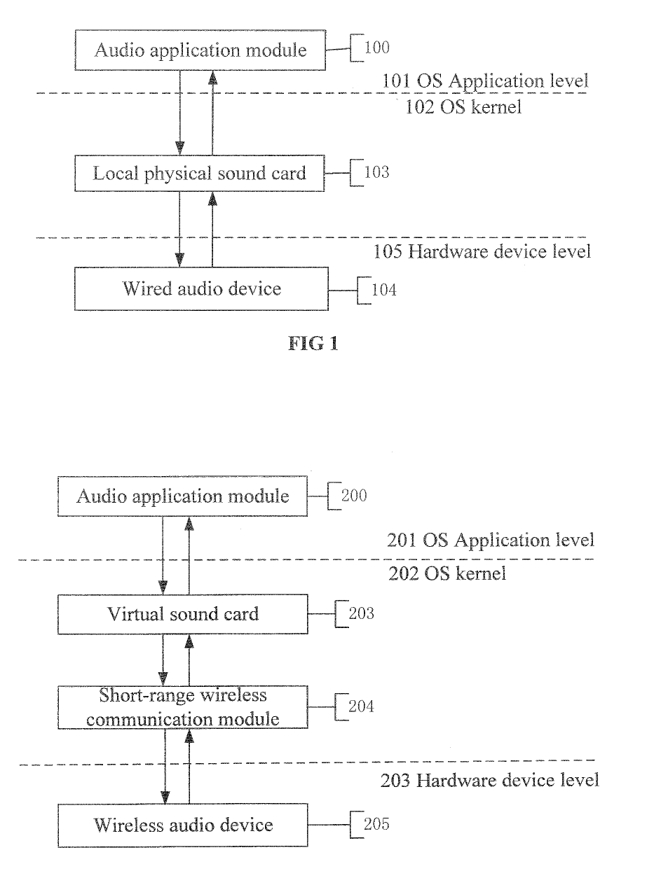

FIG. 1 is the diagram that audio data stream, which is output from/input to audio application module, is input to/output from local physical sound card in existing technology. Shown as in FIG. 1, the local physical sound card 103 is the device by the way of hardware to realize data stream acquisition and output. The local physical sound card 103 is sending audio data stream from audio application module 100 to wired audio device 104.

Preferably, audio application module 100 is realized as audio player in operating system, such as RealPlayer and Media Player, which belongs to operating system application level 101. Local physical sound card 103 belongs to operating system core level 102. The related interface between application level 101 and core level 102 of operating system is used to coordinate audio data stream transmission between audio application module 100 and local physical sound card 103.

For audio application module 100 used to make calls, including Instant Messenger, such as Skype and MSN, and VoIP network telephone system, if the input sound card is local physical sound card 103, it is necessary to pass audio data stream from local audio device 104(such as wired speaker) to local physical sound card 103, and then to audio application module 100 through the interface between operating system core level 101 and operating system core level 102.

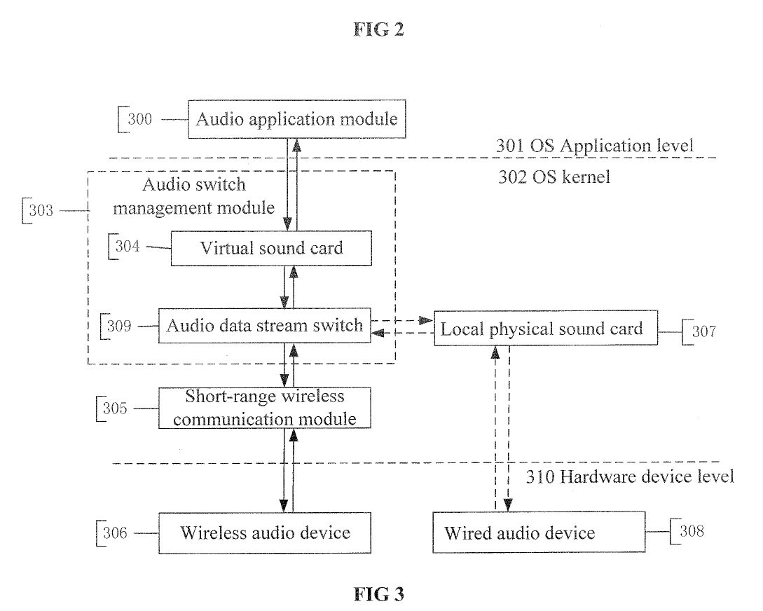

FIG. 2 is the diagram of audio data stream, which is output from/input to audio application module to/from wireless audio communication channel in existing technology.

Shown as in FIG. 2, virtual sound card 203 is software module to realize audio data stream acquisition and output. Operating system can be divided into application level 201 and core level 202, wherein, audio application module 200 is located at operating system application level 201 and virtual 203, at operating system core level 202. The related interface between application level 201 and core level 202 of operating system is used to coordinate audio data stream transmission between audio application module 200 and virtual sound card 203.

If the input sound card of audio application module 200 (such as RealPlayer and Media Player) is virtual sound card 203, audio application module 200 will pass audio data stream to virtual sound card 203, and then to wireless audio device 205 of hardware device level 206 via wireless audio communication channel of short-range wireless communication module 204.

For audio application module 200 used to make calls, including Instant Messenger, such as Skype and MSN, and VoIP network telephone system, if the input sound card is virtual sound card 203, it is necessary for wireless audio device 205 to pass audio data stream from the above wireless audio device 204 to virtual sound card 203, and then to audio application module 200.

Wherein, short-range wireless communication module 204 can be, but not limited to, Bluetooth module, Wi-Fi module and UWB module. Correspondingly, wireless audio device 205 can be Bluetooth audio device, Wi-Fi audio device and UWB audio device.

The Bluetooth communication channel is established between Bluetooth module and Bluetooth audio device in order to pass audio data stream. Similarly, The Wi-Fi audio communication channel is established between Wi-Fi module and Wi-Fi audio device in order to pass audio data stream, and UWB audio communication channel is established between UWB module and UWB audio device in order to pass audio data stream

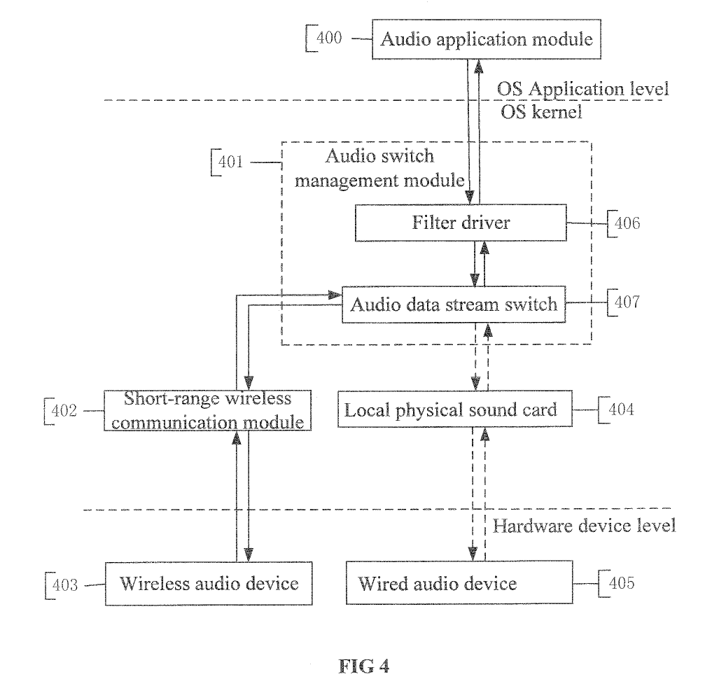

FIG. 3 is an optimized embodiment of this invention, the diagram of input/output audio data stream from/to audio application module switching seamlessly by software method between wireless audio communication channel and local physical sound card.

Shown as in FIG. 3, audio switch management module 303 includes virtual sound card 304 and audio data stream power switch 309, wherein virtual sound card 304 is used to obtain audio data streams from audio application module 300 to operating system, from wired audio system 308 of hardware device level 310 to local physical sound card 307, or from wireless audio device 306 of hardware device level 310 to wireless audio communication channel of short-range wireless communication module 305. Audio data stream power switch 309 is used to acquire the sign of connection state or disconnection state of wireless audio communication channel via short-range wireless communication module 305, and then the switch 309, according to the connection state, will control virtual sound card 304 to receive audio data stream output by audio application module 300 and send to wired audio device from local physical sound card 307, or send from wireless audio communication channel of short-range wireless communication module to wireless audio device 306. In the input direction of audio data stream of audio application module 300, the said audio data stream switch 309 controls virtual sound card 304 to receive audio data stream from wireless audio device 308 to local physical sound card 307, or receive audio data stream from wireless audio device 306 to wireless audio communication channel of short-range wireless communication module 305, and send the data stream obtained to audio application module 300.

Virtual sound card 304 and local physical sound card 307 can be presented by the way of sound card (or audio device and others) to users in operating system. It is users or audio switch management module 303 that choose virtual 304 or local physical sound card 307 to be set as default input sound card or default output sound card, which is used as input/output audio data stream of default input/output audio application module 300. The related interface between operating system application level 301 and operating system core level 302 is used to coordinate audio data stream transmission between audio application module 300 and virtual sound card 304 and local physical sound card 307.

An optimized plan is, but not limited to, that the initial states of virtual sound card 304 and audio data stream power switch 309 of audio switch management module 303 are disabled. When users can only pass input/output audio data stream from wired audio device 308 to audio application module 300 via local physical sound card 307, local physical sound card 307 will be default input/output sound card in operating system and virtual sound card 304 and audio data stream power switch 309 of audio switch management module 303 do not work, so as to avoid the unnecessary system consumption because of the working state. At this time, audio data stream input/output in operating system is shown as in FIG. 1, so the detailed introduction is not described in FIG. 3. However, when short-range wireless communication module 305 is activated, virtual sound card 304 and audio data stream power switch 309 are automatically set as usable mode, wherein, virtual sound card 304 is set automatically as default input/output sound card in operating system. At this time, if audio application module 300 is activated, it is virtual sound card 304, not local physical sound card 307, that obtains audio data stream which is input/output to/from audio application module 300. Therefore, audio data stream switch can totally control input/output audio data stream from/to audio application module 300 switching seamlessly by software method between wireless audio communication channel of short-range wireless communication module and local physical sound card 307, so as to avoid the problem of audio data stream input/output interruption after wireless audio communication channel of short-range wireless communication module 305 is established and virtual sound card 304 is activated.

After virtual sound card 304 receives audio data stream from audio application module 300, audio data stream switch 309, according to the sign of connection state of wireless audio communication channel, will control virtual sound card 304 to output audio data stream switching seamlessly by software method between local physical sound card 307 and wireless audio communication channel of short-range wireless communication module 305.

When the sign of connection state jus that wireless audio communication channel of short-range wireless communication module 305 is connected, audio data stream will be sent from wireless audio device 306, which audio data stream switch 309 controls virtual sound card 304 to receive through wireless audio communication channel of short-range wireless communication module 305. The said audio data stream will stop passing from wired audio device 308 to local physical sound card 307. When the sign of connection state judges that wireless audio communication channel of short-range wireless communication module 305 is disconnected, audio data stream will be sent from wireless audio device 306, which audio data stream switch 309 controls virtual sound card 304 to receive through local physical sound card 307. The said audio data stream will stop passing from wireless audio device 306 to wireless audio communication channel of short-range wireless communication module 305.

In the audio data stream input direction of audio application module 300, audio data stream switch 309, according to sign of connection state of wireless audio communication channel of short-range wireless communication module 305, controls virtual sound card 304 to receive audio data stream switching seamlessly by software method between local physical sound card 307 and wireless audio communication channel of short-range wireless communication module 305.

When the sign of connection sign judges that wireless audio communication channel of short-range wireless communication module 305 is connected, audio data stream switch 309 controls virtual sound card 304 to receive audio data stream, which is input from wireless audio device 306, through wireless audio communication channel of short-range wireless communication module 305, and then sends to audio application module 300. At the same time, virtual sound card 304 stops passing audio data stream from wired audio device 308 to local physical sound card 307. When the sign of connection state judges that wireless audio communication channel of short-range wireless communication module 305 is disconnected, audio data stream switch 309 will control virtual sound card 304 to receive audio data stream, which is input from wired audio device 308, through local physical sound card 307, then send to audio application module 300. At the same time, virtual sound card 304 will stop passing audio data stream from wireless audio device 306 to and wireless audio communication channel of short-range wireless communication module 305.

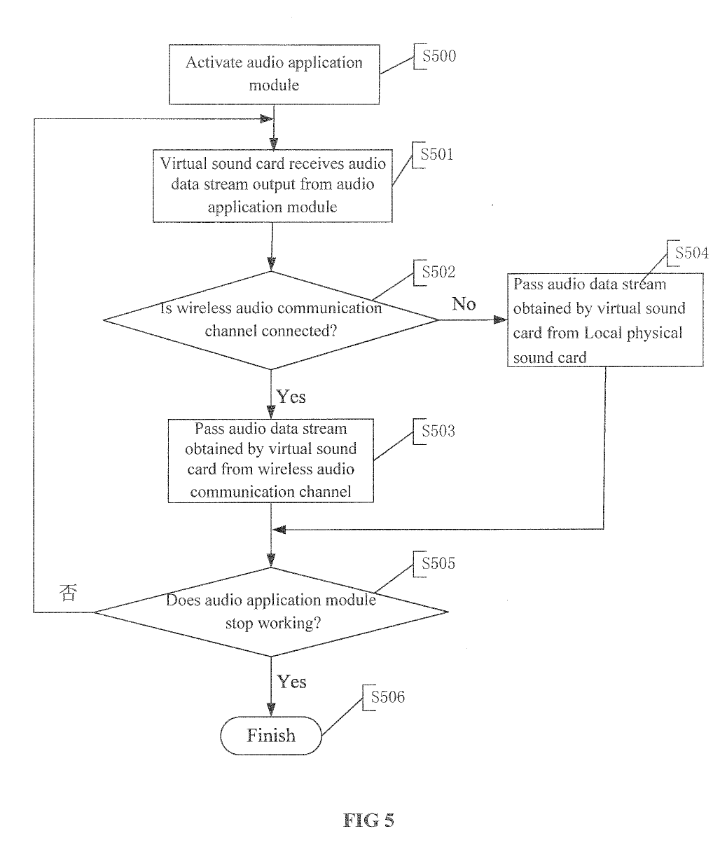

FIG. 4 is an optimized embodiment of this invention, the diagram of input/output audio data stream from/to audio application module switching seamlessly by software method between wireless audio communication channel and local physical sound card.

It is to be noted that modules and devices in FIG. 4 and FIG. 3 have the same functions, which are not detailed here. The difference is that, in audio switch management module 401 of FIG. 4, filter driver 406 is replaced by virtual sound card 304 in FIG. 3. That is to say, in the embodiment of FIG. 4, operating system shows to users as a sound card (local physical sound card 404). Users or audio switch management module 401 can only set up local physical sound card 404 as input/output device of audio application module 400. Filter driver 406 is placed between local physical sound card 404 and audio application module 400 to intercept audio data stream that audio application module 400 inputs to local physical sound card 404, and receive audio data stream from local physical sound card 404 or wireless audio communication channel of short-range wireless communication module 402, and send the said stream to audio application module 400. Therefore, filter driver 406 of audio switch management module 401 and audio data stream switch 407 must be kept in working mode, in order to obtain and control input/output audio data stream switching of audio application module 400 seamlessly by software method.

After filter driver 406 of audio switch management module 401 intercepts audio data stream from audio application module 400 to local physical sound card 404, audio data stream switch 407 of audio switch management module 401, according to the sign of connection state from short-range wireless communication module 402, will control audio data stream switching seamlessly by software method, which is intercepted by filter driver 406 from audio application module 400, between local physical sound card 404 and wireless audio communication channel of short-range wireless communication module 402. When the sign of connection state judges that wireless audio communication channel of short-range wireless communication module 402 is connected, audio data stream switch 407 will control to send audio data stream, which is intercepted by filter driver 406 from audio application module 400, to wireless audio device 403, through wireless audio communication channel of short-range wireless communication module 402, and, at the same time, stop passing audio data stream, which is intercepted by filter driver 406 from audio application module 400, from wired audio device 405 to local physical sound card 404. When the sign of connection state judges that wireless audio communication channel of short-range wireless communication module 402 is disconnected, audio data stream switch 407 will control filter driver 406 to intercept audio data stream, which is input by audio application module 400, to wired audio device 405, through local physical sound card 404, and, at the same time, stops passing audio data stream, which is intercepted by filter driver 406 from audio application module 400, from wireless audio communication channel of short-range wireless communication module 402 to wireless audio device 403.

In the input direction of audio data stream of audio application module 400, audio data stream switch 407, according to sign of connection state of wireless audio communication channel of short-range wireless communication module 402, will control audio data stream switching seamlessly by software method, which is intercepted by filter driver 406, between local physical sound card 404 and wireless audio communication channel of short-range wireless communication module 402. When the sign of connection state judges that wireless audio communication channel of short-range wireless communication module 402 is connected, audio data stream switch 407 will control filter driver 406 to receive audio data stream, which wireless audio device 403 inputs, through wireless audio communication channel of short-range wireless communication module 402, and send to audio application module 400. At the same time, filter driver 406 will stop passing audio data stream from wired audio device 405 to local physical sound card 404. When the sign of connection state judges that wireless audio communication channel of short-range wireless communication module 402 is disconnected, audio data stream switch 407 will control filter driver 406 to receive audio data stream, which wired audio device 405 inputs, through local physical sound card 404, and at the same time, will stop passing audio data stream from wireless audio device 403 to wireless audio communication channel of short-range wireless communication module 402.

FIG. 5 is, according this invention, the diagram of output audio data stream from audio application module switching seamlessly by software method between wireless audio communication channel and local physical sound card. Shown as in FIG. 5, after audio application module S500 is activated, virtual sound card (or filter driver) receives audio data stream S501, which audio application module sends to operating system. And then audio switch management module judges if wireless audio communication channel of short-range wireless communication module is in the connection state S502. In the connection state, audio switch management module will send audio data stream, which is obtained by virtual sound card (or filter driver) from audio application module, from wireless audio communication channel of short-range wireless communication module to wireless audio device S503. Otherwise, audio switch management module will send audio data stream, which is obtained by virtual sound card (or filter driver) from audio application module, from local physical sound card to wired audio device S504. And then check whether audio application module stops working S505. If audio application module has stopped working, finish S506. Otherwise, repeat the above steps S501-S505.

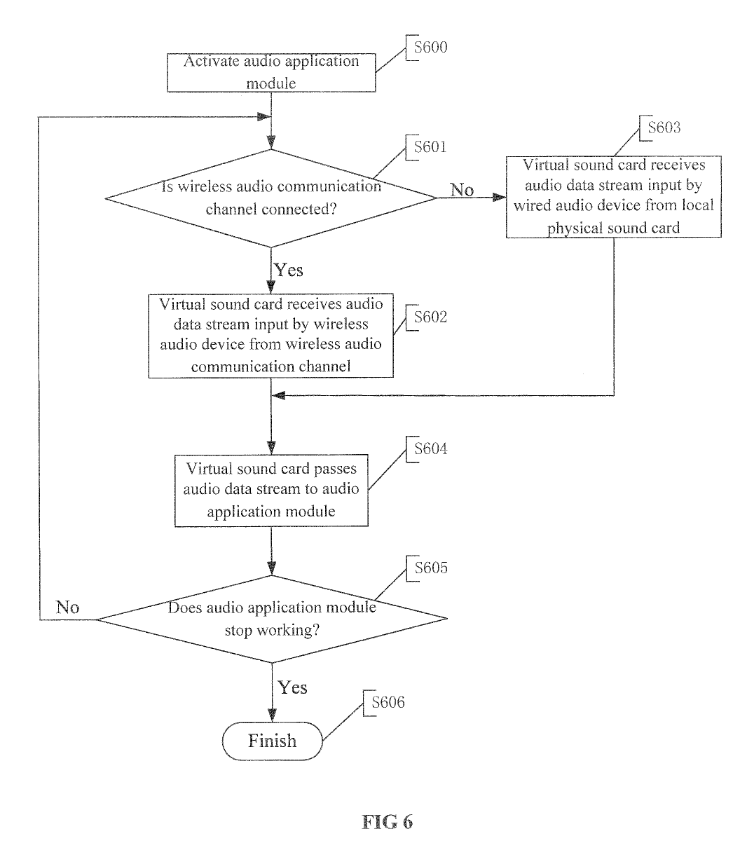

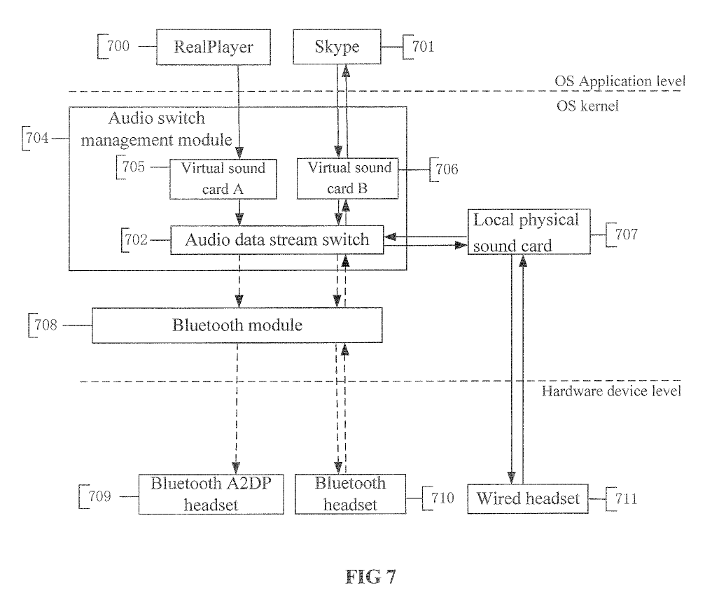

FIG. 6 is, according this invention, the diagram of input audio data stream to audio application module switching seamlessly by software method between wireless audio communication channel and local physical sound card.

Shown as in FIG. 6, when audio application module S600 is activated, audio switch management module will judge whether wireless audio communication channel of short-range wireless communication module is in the connection state S601. If in the connection state, audio switch management module will control virtual sound card (or filter driver) to receive input audio data stream S602 to wireless audio device through wireless audio communication channel of short-range wireless communication module. Otherwise, virtual sound card (or filter driver) will receive audio data stream, which is input from wired audio device to local physical sound card, and then send the said audio data stream to audio application module S604. And then check whether audio application module stops working S605. If audio application module has stopped working, finish S606. Otherwise, repeat the above steps S601-S605.

FIG. 7 is, according this invention, the diagram of switching seamlessly by software method of two Bluetooth audio applications in accordance with optimized embodiment.

Shown as in FIG. 7, audio switch management module 704 has two virtual sound cards, A705 and B706, with virtual sound card A705 as the designated output sound card of audio application module RealPlayer 700, and virtual sound card B706 as the designated input/output sound card of audio application module Skype 701. Audio data stream switch 702 will receive, through Bluetooth module 708, the sign of connection state of Bluetooth ACL communication channel between Bluetooth A2DP headset 709 and Bluetooth module 708. When the sign of connection state recognizes that Bluetooth ACL communication channel between Bluetooth A2DP headset 709 and Bluetooth module 708 is connected, audio data stream switch 702 will control virtual sound card A705 to receive audio data stream output from RealPlayer, and then send the stream to Bluetooth A2DP headset 709 through Bluetooth module 708 ACL communication channel. At the same time, audio data stream switch 702 can receive, through Bluetooth module 708, the sign of connection state of Bluetooth SCO communication channel between Bluetooth headset 710 and Bluetooth module 708. When the sign of connection state recognizes Bluetooth SCO communication channel between Bluetooth headset 710 and Bluetooth module 708 is connected, users of Bluetooth module 708 and Skype 701 contacts can make the voice call through Bluetooth SCO communication channel. That is to say, audio data stream switch 702 controls virtual sound card B706 to receive audio data stream output from Skype 701, and to send to Bluetooth headset 708 through Bluetooth module 708 SCO communication channel. It also controls virtual sound card B707 to receive audio data stream output from Bluetooth headset 708 through Bluetooth module 708 SCO communication channel, and then to send to Skype 701. Thus, when users of Bluetooth A2DP headset 709 are listening music played by RealPlayer 700, and users of Bluetooth headset 710 are making calls with Skype 701 contacts, they will not interfere with each other, and there will be no audio data stream mixing sound of RealPlayer 700 and Skype 701.

When only Bluetooth ACL audio communication channel is disconnected, audio data stream switch 702 will control virtual sound card A705 to switch audio data stream, which is output from RealPlayer 700, to local physical sound card 707, and then to send to wired headset 711, and stop passing audio data stream from RealPlayer 700 to Bluetooth ACK communication channel of Bluetooth module 708. When only Bluetooth SCO audio communication channel is disconnected, audio data stream switch 702 will control virtual sound card B706 to switch input/output audio data stream to/from Skype 701 to wired headset 711 through local physical sound card 707. When both Bluetooth ACL and SCO audio communication channels are disconnected due to inoperative station of Bluetooth module 708 or other reasons, audio data stream switch 702, in accordance with the optimized strategy set apart, will control one of virtual sound card A705 and virtual sound card B706 to switch input/output audio data stream to/from audio application module to local physical sound card 707, and control another virtual sound card not to switch audio data stream obtained to local physical sound card 707, so as to avoid sound mixing. For example, if virtual sound card B706 is set as preferred to virtual sound card A705, audio data stream switch 702, will control virtual sound card B706 to switch Skype 701 input/output audio data stream to wired headset 711 through local physical sound card 707, in order to assure the incessant working of Skype 701 calls.

While embodiments of this invention have been shown and described herein for purposes of illustration, within the true spirit and scope of this invention and the appended claims, many modifications and changes will become apparent to those skilled in the art. Therefore, this invention is not limited to those optimized embodiments, but covered with this change. This invention exists in each and any new characteristics, and each and any combination of characteristics.

It is obvious for those skilled in the art, that “module” is used to cover any hardware (such as separate or integrated circuit or electronic unit) or software (such as program or subprogram). This invention can be realized through hardware with different units and through computer with programming. “Software” should be understood as any software product saved on computer readable media (such as floppy disk), downloaded from network (such as Internet) or sold by other ways.

1. A digital device, comprising:
at least one audio application module, used to send an output audio data stream and/or receive an input audio data stream;
at least one local physical sound card, used to send the output audio data stream to a wired audio device and/or receive the input audio data stream from the wired audio device;
at least one short-range wireless communication module, used to send the output audio data stream to a wireless audio communication channel and/or receive the input audio data stream through the wireless audio communication channel;
an audio switch management module, including at least one virtual sound card, which is used to send the output audio data stream generated by the audio application module to the local physical sound card or the short-range wireless communication module, and/or send the input audio data stream from the local physical sound card or the short-range wireless communication module to the audio application module;
when the audio switch management module is activated, the virtual sound card is automatically configured as a default input sound card of the input audio data stream and a default output sound card of the output audio data stream for an operating system of the digital device;
when the wireless audio communication channel is connected, the audio switch management module will automatically switch the output audio data stream, which the virtual sound card obtains from the audio application module, to the wireless audio communication channel, and stop sending the audio data stream to the local physical sound card, and/or transmit the input audio data stream, which the virtual sound card obtains from the wireless audio communication channel, to the audio application module, and stop the receiving input audio data stream from the local physical sound card; and
when the wireless audio communication channel is disconnected, the audio switch management module will automatically switch the output audio data stream, which the virtual sound card obtains from the audio application module, to the local physical sound card, and stop sending the output audio data stream to the wireless audio communication channel, and/or send the input audio data stream, which the virtual sound card obtains from the local physical sound card, to the audio application module, and stop receiving the input audio data stream from the wireless audio device.

2. The device of claim 1, wherein:
the short-range wireless communication module records a sign of a connection state to identify the connection state of the wireless audio communication channel; and
the audio switch management module controls the operation of the audio switch management module, according to the sign of the connection state.

3. The device of claim 1, wherein when the audio switch management module stops working, the virtual sound card is set as “disabled”, and the local physical sound card is set as the default input sound card of the input audio data stream and the default output sound card of the output audio data stream in the operating system.

4. (canceled)

5. The device of claim 1, wherein:
the operating system has more than one short-range wireless communication module which shares the virtual sound card;
when all wireless audio communication channels of the multiple short-range wireless communication modules are disconnected, the audio switch management module will send the output audio data stream to the wired audio device through the local physical sound card, and stop sending the output audio data stream to the multiple short-range wireless communication modules, and/or transmit the input audio data stream by the local physical sound card to the audio application module, and stop receiving the input audio data stream from the multiple short-range wireless communication modules; and
when at least one wireless audio communication channel of the multiple short-range wireless communication modules is connected, the audio switch management module will send the output audio data stream to at least one connecting wireless audio device, and stop sending the output audio data stream to the local physical sound card, and/or transmit the input audio data stream from at least one wireless communication channel to the audio application module, and stop receiving the input audio data stream from the local physical sound card.

6. The device of claim 1, wherein:
the audio switch management module has more than one virtual sound card, and among the multiple virtual sound cards and the local physical sound card, only one is configured as the default input/output sound card in the operating system;
when the default audio application module imports an input sound card of the input audio data stream and exports an output sound card of the output audio data stream, the default input sound card will receive the input audio data stream, and the default output sound card will receive the output audio data stream;
when other sound cards, except the default input/output sound card, are designated as the input/output sound card of the audio application module, the designating sound card can receive the input/output audio data stream of the audio application module.

7. The device of claim 6, wherein:
the audio switch management module has a first virtual sound card and a second virtual sound card;
the first virtual sound card is designated as an input and output sound card of the first audio application module, which corresponds to a first wireless audio communication channel of the short-range wireless communication module;
the second virtual sound card is designated as an input and output sound card of the second audio application module, which corresponds to a second wireless audio communication channel of the short-range wireless communication module;
wherein, when the first wireless audio communication channel is connected, the audio switch management module will send the output audio data stream, obtained from the first virtual sound card, to the first wireless audio communication channel, and/or control the first virtual sound card to send the input audio data stream, which is obtained from the first wireless communication channel, to the first audio application module, and when the first wireless audio communication channel is disconnected, the audio switch management module will send the output audio data stream from the first virtual sound card to the local physical sound card, and/or transmit the input audio data stream from the local physical sound card to the first audio application module;
wherein, when the second wireless audio communication channel is connected, the audio switch management module will send the input audio data stream by the second virtual sound card to the second wireless audio communication channel, and/or control the second virtual sound card to send the input audio data stream by the second wireless communication channel to the second audio application module;
when the second wireless audio communication channel is disconnected, the audio switch management module will send the output audio data stream obtained by the second virtual sound card to the local physical sound card, and/or control the second virtual sound card to send the input audio data stream by the local physical sound card to the second audio application module.

8. The device of claim 7, wherein when both the first wireless audio communication channel and the second wireless audio communication channel are disconnected, the audio switch management module will, according to a priority strategy, automatically switch the input/output audio data stream, by the first or the second audio application module, to the local physical sound card.

9. The device of claim 7, wherein the first wireless audio communication channel is a Bluetooth ACL communication channel of a Bluetooth audio application A2DP with high quality; and the second wireless audio communication channel is a Bluetooth SCO/eSCO communication channel of a Bluetooth voice audio application.

10. The device of claim 1, wherein the short-range wireless communication module includes a Bluetooth module, a Wi-Fi module and a UWB module.

11. A digital device, comprising:
at least one audio application module, used to produce an output audio data stream and/or receive an input audio data stream;
at least one local physical sound card, used to transmit the output audio data stream to a wired audio device and/or receive the input audio data stream from the wired audio device;
at least one short-range wireless communication module, used to transmit the output audio data stream to a wireless audio communication channel and/or receive the input audio data stream through the wireless audio communication channel;
an audio switch management module, which is comprised of a filter driver that is placed between the audio application module and the local physical sound card and is used to intercept the output audio data stream from the audio application module to the local physical sound card, as well as the input audio data stream from the local physical sound card and the short-range wireless communication module;
wherein the filter driver and the local physical sound card are displayed as the only physical sound card in an operating system of the digital device;
when the audio switch management module is activated, the virtual sound card is automatically configured as a default input sound card of the input audio data stream and a default output sound card of the output audio data stream for an operating system of the digital device;
when the wireless audio communication channel is connected, the audio switch management module will switch the output audio data stream by the audio application module to the wireless audio communication channel, and stop sending the audio data stream to the local physical sound card, and/or transmit the input audio data stream, which the filter driver obtains from the wireless audio communication channel, to the audio application module, and stop the receiving input audio data stream from the local physical sound card; and
when the wireless audio communication channel is disconnected, the audio switch management module will switch the output audio data stream by the audio application module, to the local physical sound card, and stop sending the output audio data stream to the wireless audio communication channel, and/or transmit the input audio data stream, which the filter driver obtains from the local physical sound card, to the audio application module, and stop receiving the input audio data stream from the wireless audio device.

12. A method of playing an audio data stream in a digital device wherein the digital device includes at least one local physical sound card, at least one short-range wireless communication module, and an audio switch management module including at least one virtual sound card that is used to pass the audio data stream between an audio application module and the local physical sound card or the short-range wireless communication module, the method comprising the steps of:
when the audio switch management module is activated, automatically setting the virtual sound card as a default input/output sound card for the audio data stream in an operating system of the digital device;
judging a connection state of the wireless audio communication channel of the short-range wireless communication module;
if the connection state of the wireless audio communication channel is changed to connected, automatically switching the audio data stream between the audio application module and the local physical sound card via the virtual sound card to the audio application module and the wireless communication module via the virtual sound card, and stopping use of the local physical sound card; and
if the connection state of the wireless audio communication channel is changed to disconnected, automatically switching the audio data stream between the audio application module and the wireless communication module via the virtual sound card to the audio application module and the local physical sound card via the virtual sound card, and stopping use of the wireless audio communication channel.

13. The method of claim 12, further comprising the step of:
if the audio switch management module stops working, setting the virtual sound card to “disabled”, setting the local physical sound card as the default input/output sound card for the audio data stream in the operating system.

14. (canceled)

15. The method of claim 12, wherein the steps are executed according to a sign of the connection state generated from the short-range wireless communication module.

16. The method of claim 12, wherein the digital device has more than one short-range wireless communication module and the multiple short-range wireless communication modules share the virtual sound card, the method further comprising:
when all the wireless audio communication channels are disconnected, passing the input/output audio data stream, which the virtual sound card obtains from the audio application module, to the wired audio device via the local physical sound card, and stop inputting/outputting through the wireless audio communication channels of the multiple short-range wireless communication channels; and
when at least one of the wireless audio communication channels is connected, switching the input/output audio data stream, generating which the virtual sound card obtains from the audio application module, to the connecting wireless audio communication channel, and stop inputting/outputting to/from the wired audio device through the local physical sound card.

17. The method of claim 12, wherein:
the audio switch management module has more than one virtual sound card, and only one of the multiple virtual sound cards or the local physical sound card is set as the default input sound card of the input audio data stream, and as the default output sound card of the output audio data stream, and when a computer starts up, the input default sound card receives the input audio data stream, and the output default sound card receives the output audio data stream; and
when other sound cards except the default input/output sound card are designated as the input/output sound card of the audio application module, the designating sound card can receive the input/output audio data stream.

18. The method of claim 17, wherein the audio switch management module has the first virtual sound card and the second virtual sound card, the first virtual sound card is designated as the input/output sound card of the first audio application module, which corresponds to the first wireless audio communication channel of the short-range wireless communication module, and the second virtual sound card is designated as the input/output sound card of the second audio application module, which corresponds to the second wireless audio communication channel of the short-range wireless communication module, and wherein the method further comprises the steps of:
when the first wireless audio communication channel is connected, passing the output audio data stream of the first audio application module via the first virtual sound card to the first wireless audio communication channel, and at the same time, passing the input audio data stream from the first wireless audio communication channel to the first audio application module;
when the first wireless audio communication channel is disconnected, passing the output audio data stream of the first audio application module to the local physical sound card via the first virtual sound card, and at the same time, passing the input audio data stream is from the local physical sound card to the first audio application module;
when the second wireless audio communication channel is connected, passing the output audio data stream of the second audio application module via the second virtual sound card to the second wireless audio communication channel, and at the same time, passing the input audio data stream from the second wireless audio communication channel to the second audio application modules; and
when the second wireless audio communication channel is disconnected, passing the output audio data stream of the second audio application module via the second virtual sound card to the local physical sound card, and at the same time, passing the input audio data stream from the local physical sound card to the second audio application module.

19. The method of claim 18, further comprising the steps of:
when both the first wireless audio communication channel and the second wireless audio communication channel are disconnected, switching, in accordance with a priority strategy, the input/output audio data stream of the first audio application module or the second application module to the local physical sound card.

20. The method of claim 17, wherein the first wireless audio communication channel comprises a Bluetooth ACL communication channel of a Bluetooth audio application A2DP with high quality; and the second wireless audio communication channel comprises a Bluetooth SCO/eSCO communication channel of a Bluetooth voice audio application.

21-22. (canceled)

23. A method of seamlessly switching an input/output audio data stream in an operating system comprising at least one local physical sound card, at least one short-range wireless communication module, and an audio switch management module to pass the input/output audio data stream to/from the local physical sound card or the short-range wireless communication module, the method comprising the steps of:
providing a filter driver between an audio application module and the local physical sound card to intercept the input/output audio data stream from the audio application module to the local physical sound card, as well as the input audio data stream from the local physical sound card and the short-range wireless communication module, and wherein the filter driver and the local physical sound card are displayed as the only physical sound card in the operating system;
judging a connection state of the wireless audio communication channel of the short-range wireless communication module;
if the connection state of the wireless audio communication channel is changed to connected, automatically switching the input/output audio data stream between the audio application module and the local physical sound card via the filter driver to the audio application module and the wireless communication module via the filter driver, and stopping use of the local physical sound card; and
if the connection state of the wireless audio communication channel is changed to disconnected, automatically switching the input/output audio data stream between the audio application module and the wireless communication module via the filter driver to the audio application module and the local physical sound card via the filter driver, and stopping use of the wireless audio communication channel.
